(19) United States
(12) Patent Application Publication
(10) Pub. No.: US 2003/0050964 A1
(43) Pub. Date: Mar. 13, 2003

(54) Method and system for context manager proxy

(76) Inventors: Philippe Debaty, Palo Alto, CA (US); Deborah Lynn Caswell, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 09/949,488

(22) Filed: Sep. 7, 2001

(51) Int. Cl. G06F 15/16

(52) U.S. Cl. 709/203; 709/246

(57) ABSTRACT

A method for providing user context information to customize responses from a Web server. The method includes the step of receiving user context information from a user and receiving an HTTP request from the user for information from a Web server. The user context information is added to the HTTP request. The HTTP request is transmitted with the user context information to the Web server to obtain a customized response from the Web server. The customized response is then forwarded to the user. The user context information received from the user can be stored in a proxy server. The user context information is received in accordance with Internet communication standards, and a proxy server can be used to receive the HTTP request from the user and to forward the customized response from the Web server to the user. The user context information can be appended to the HTTP request by using a cookie HTTP header or by using an extended HTTP header. A Web page interface can be provided to allow the user to access and edit the user context information. The user context information can include user location information or user identity information. The method thus facilitates the customization of information presented from a variety of different Web sites or Web portals with respect to an individual user.

### TECHNICAL FIELD

The present invention relates generally to accessing information and obtaining services from the Internet by using client devices. More specifically, the present invention pertains to a method and system for implementing context sensitive information access and retrieval from the Internet using a variety of different electronic devices.

### BACKGROUND ART

The use of the Internet for electronic commerce and for information retrieval has rapidly proliferated in today's modern world. Hundreds of Internet sites and Web portals are constantly accessed by millions of users for obtaining information, news, entertainment, and the like, via the World Wide Web. Many aspects of everyday life are becoming electronically information based, and the access, control, and the use of such electronic information, through the use of various types of electronic devices, is never far from hand. For example, a desktop computer allows access to banking functions (e.g., checking, bill paying, etc.), shopping (e.g., groceries, clothing, etc.), the weather, and virtually any other need of an individual. A handheld computer device (e.g., a personal information device such as a palmtop computer, cellphone, or the like) allows such access to be always close at hand. Many users are increasingly relying upon the Internet to fill all the basic everyday needs. Users have become familiar with the Internet destinations which helped to accomplish whatever business or pleasure they require.

One type of widely used Internet (e.g., or more particularly, the World Wide Web) destination is a Web portal. A Web portal is generally a large collection of related Web pages that provide a variety of services including Web searching, news, white and yellow pages directories, free e-mail, discussion groups, online shopping and links to other sites. Web portals originally became popular for searching for thousands of Web sites the Internet for specific information. The Web portal term has evolved over time to refer to general purpose sites. In addition to being general-purpose Internet destinations, some Web portals have evolved into vertical market sites that offer specific services and have specific themes, but only to a particular industry such as banking, insurance or computers, or fulfill specific needs for certain types of users, for example, travelers searching for the best airfares, hotel arrangements, or the like.

As specific themed Web portals have become more popular, there has been a trend towards the provision of more individualized and customized information and services to users. For example, certain types of Web portals have evolved into customized, user type specific sources of information. One example would be a travel Web site, wherein individualized presentations of menu choices, links, and the like, developed specifically for the preferences of an individual user, are presented after a sign-in process whereby a user identifies himself. Such a Web site would typically include a customized search engine for airfares, hotels, and the like, as well as the ability to customize the portal page for different destinations and tastes. Access to such customized Web sites by business travelers, or other types of users who require concise prompt access to information, is a highly sought-after goal. Web sites implement such customization by keeping track of user identity, such that when the user initially enters preferences and subsequently returns to the Web site, the customized presentation can be generated and a familiar GUI (graphical user interface) having a familiar “look and feel” can be presented through the user's Web browser.

Thus, a variety of different mechanisms have evolved for tracking a user's identity and a user's preferences to allow the customization. The majority of such mechanisms can be characterized as the use of electronic “cookies” placed on the user's client machine. The cookie mechanism, in its various forms, allows the different Web sites to store the information regarding identity, preferences, etc. on the users client machine for later access during subsequent visits.

Generally, cookies are data created by a Web server that is stored on a user's client machine. Cookies provide a way for the Web site to keep track of a user's patterns and preferences and, with the cooperation of the Web browser, to store them on the user's own hard disk.

The cookies typically contain a range of URLs (addresses) for which they are valid. When the user's Web browser encounters those URLs again, it sends those specific cookies to the Web server. For example, if a user's ID were stored as a cookie, it would save that person from typing in the same information all over again when accessing that service for the second and subsequent time. By retaining user history, cookies allow the Web site to tailor the pages and create a custom experience for that individual.

There exists a number of problems with the cookie mechanism however. Due to the fact that traditional Web services retrieve client information using the Cookie mechanism, the cookies always need to be first set by the Web server. Additionally, to facilitate subsequent access by the Web server, the cookies are tightly associated with the Web server. Therefore, the user has to go through the first step of setting up preferences for every different Web service. A large amount of redundant information must be entered for every different Web site, Web portal, or information source the user requires.

Another problem is the fact that in a mobile environment (e.g., a business traveler) where the user is accessing many Web services and has highly varying context information (e.g., location, lodging requirements, telephone numbers, etc.), this model is not appropriate. Indeed, it requires the user to set its preferences for every service and to update it every time his contextual information, such as his location, changes.

With respect to portable devices, although many different standards have been developed, such as, for example, WML (wireless markup language) and WAP (wireless application protocol), to provide customized information to business travelers and other various types of users, there currently exists no standardized mechanism that avoids the redundant entry of user context information (e.g., preferences, location, identity, etc.). There exists no mechanism for the automatic updating of user context with a large number of Web services a user may require.

Thus what is required, is a solution that can facilitate the customization of information presented from a variety of different Web sites or Web portals with respect to an individual user. The required solution should automatically transmit context information in accordance with the widely used Internet communication standards. The present invention provides a novel solution to the above requirements.

### DISCLOSURE OF THE INVENTION

The present invention is a method and system for a context manager proxy that facilitates the customization of information presented from a variety of different Web sites or Web portals with respect to an individual user. The present invention automatically transmits context information in accordance with the widely used Internet communication standards to allow the customization of responses from various Web sites or Web portals.

In one embodiment, the present invention is implemented as a proxy server based method for providing user context information to customize responses from a Web server. The method includes the step of receiving user context information from a user and receiving an HTTP request from the user for information from a Web server. The user context information is added to the HTTP request. The HTTP request is transmitted with the user context information to the Web server to obtain a customized response from the Web server. The customized response from the Web server is then forwarded to the user.

The user context information received from the user can be stored and maintained in the proxy server. The user context information is received in accordance with Internet communication standards, and a proxy server can be used to receive the HTTP request from the user and to forward the customized response from the Web server to the user. The user context information can be appended to the HTTP request by using a cookie HTTP header or by using an extended HTTP header. A Web page interface can be provided to allow the user to access and edit the user context information. The user context information can include user location information, or user identity information, or the like. The method thus facilitates the customization of information presented from a variety of different Web sites or Web portals with respect to an individual user.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a client/server computer system in accordance with one embodiment of the present invention.

FIG. 2 shows a client/server computer system in accordance with an alternative embodiment of the present invention

FIG. 3 shows a diagram depicting the software based components executing on the computer system platform provided by proxy server in accordance with one embodiment of the present invention.

FIG. 4 shows a diagram depicting user context information appended to an HTTP request using a traditional cookie HTTP header and user context information appended to an HTTP request using an extended HTTP header in accordance with one embodiment of the present invention.

FIG. 5 shows a flow chart of the steps of a proxy server based method for providing user context information to customize responses from a Web server in accordance with one embodiment of the present invention.

FIG. 6 shows a computer system platform in accordance with one embodiment of the present invention.

### DETAILED DESCRIPTION OF THE INVENTION

Reference will now be made in detail to the embodiments of the invention, a method and system for a context manager proxy, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Embodiments of the present invention are directed towards a method and system for a context manager proxy that provides a solution that facilitates the customization of information presented from a variety of different Web sites or Web portals with respect to an individual user. The present invention automatically transmits context information in accordance with the widely used Internet communication standards to allow the customization of responses from various Web sites or Web portals.

Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to convey most effectively the substance of their work to others skilled in the art. A procedure, computer executed step, logic block, process, etc., are here, and generally, conceived to be self-consistent sequences of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

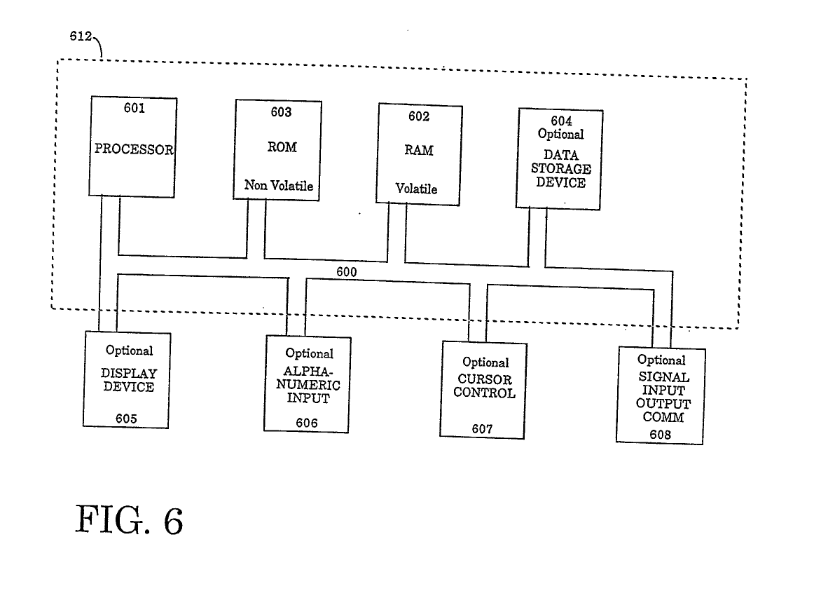

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “executing,” “receiving,” “accessing,” “editing,” “providing,” “transmitting,” storing,” or the like, refer to the action and processes of a computer system, or similar electronic computing device, that manipulates and transforms data represented as physical (electronic) quantities within the computer system's registers and memories into other data similarly represented as physical quantities within the computer system registers or memories or other such information storage, transmission, or display devices (e.g., computer system 612 of FIG. 6).

Method and System of the Invention

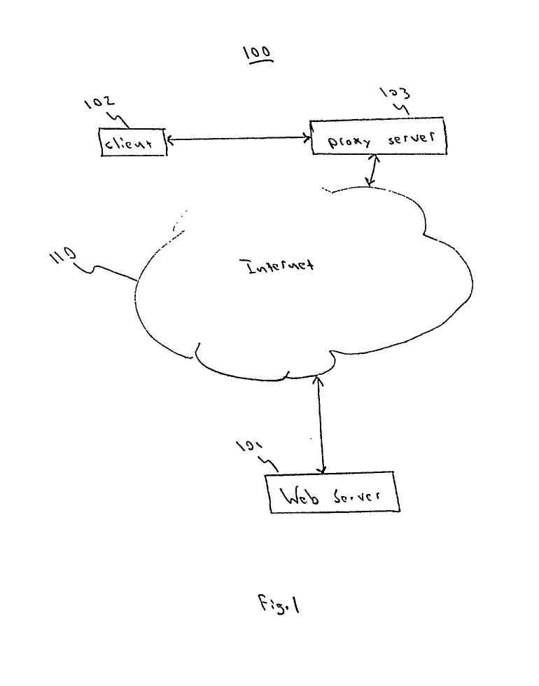

FIG. 1 shows a diagram of a client/server system 100 in accordance with one embodiment of the present invention. System 100 depicts a Web server 101 communicating with a client 102 via the Internet (or more particularly, the World Wide Web) 110 and a proxy server 103. The client 102 accesses the Internet 110 using a Web browser executing on the client 102.

FIG. 1 shows a system 100 diagramming the basic structure of one embodiment of the present invention, wherein a server 101 is used for accessing and retrieving information for one or more functions (e.g., banking, travel arrangements, directions, directory assistance, etc.) and presenting customized presentations of the information to the Web browser of the client 102. In this embodiment, server 101 is a Web portal, for serving information, news, entertainment, and the like, via the Internet 110 (e.g., the World Wide Web). As such, server 101 can provide a variety of services including Web searching, news, white and yellow pages directories, free e-mail, discussion groups, online shopping and links to other sites.

The proxy server 103, often referred to as a “proxy” or “application level gateway,” functions as an intermediary connection between a sender, for example, client 102, and a receiver, for example, Web server 101. Proxy servers, such as proxy server 103, have been implemented for a variety of different purposes. Generally, a proxy server is used to separate an internal network from the Internet. The proxy server 103 can be used to run “firewall” software, wherein internal network input is forwarded out of different ports of the proxy server in order to prevent outside agents (e.g., hackers, etc.) from obtaining internal addresses and details of the internal network.

Proxy server 103 can also run additional common Internet services, such as, for example, an SMTP proxy for e-mail. Proxy server 103 generally employs network address translation (NAT), which presents one organization-wide IP address to the Internet. In one embodiment, proxy server 103 can funnel all user requests to the Internet 110 and fan responses back out to the appropriate users (e.g., client 102). Proxy server 103 can also be used to cache Web pages, so that the next request can be obtained locally.

As is well known, the Web browser executing on client 102 communicates with Web server 101 via the TCP/IP protocol. The browser sends HTTP requests to the Web server 101 via the proxy server 103. In response, the Web server 101 responds with HTML pages (e.g., Web pages) and possibly additional programs in the form of ActiveX controls or Java applets.

In the present embodiment, proxy server 103 is used to provide user context information automatically with HTTP requests from client 102. As is well known, the term HTTP refers to Hypertext Transport Protocol, which is the communications protocol used to connect to servers (e.g. Web server 101) on the Internet 110. Its primary function is to establish a connection with a Web server and transmit HTML pages to the client browser.

Referring still to system 100 of FIG. 1, the proxy server 103 of the present embodiment solves the problem of updating user context information by automatically transmitting the user contextual information (location, identity, preferences, etc.) of the user to multiple and potentially unrelated Web services. For reasons of clarity, only one such Web server 101 is shown, however, it should be noted that the user context information can be transmitted to a large number of such Web servers. Using the user context information, the Web server 101 can customize its response to the user (e.g., client 102). The automatic transmission of user context information solves the prior art cookie mechanism problems. For example, by automatically transmitting user context information with HTTP requests from user 102, the president embodiment solves the problem wherein cookies always needed to be first set by the Web server 101 and tightly associated with the Web server 101.

Thus, in accordance with the present embodiment, user 102 need only enter preferences once, as opposed to setting up preferences for multiple different Web service. This provides a number of advantages. For example, in a mobile environment where the user is accessing many Web services and has highly varying context information, the user need only access the proxy server 103 to update the context information. The user is not required to revisit and re-enter preferences for every service and to update the preferences every time his contextual information, such as his location, changes. With the automatic transmission of user context information of the present invention, the user only sets his preference information once and the varying context is automatically updated to the Web services the user may visit.

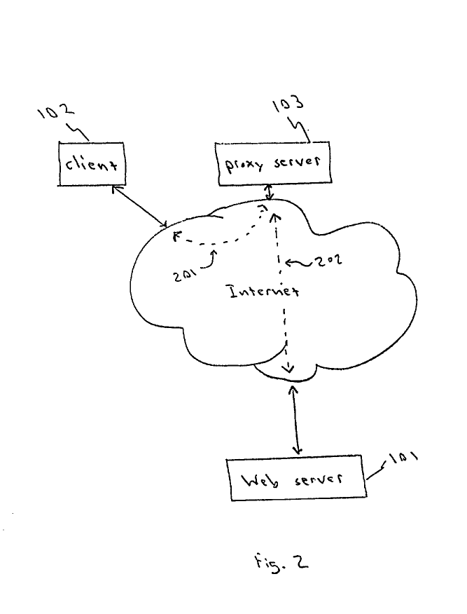

FIG. 2 shows a system 200 in accordance with one alternate embodiment of the present invention. System 200 is substantially similar to system 100, however in system 200, the client 102 communicates with the proxy server 103 via the Internet 110 as opposed to, for example, a private internal network. In this embodiment, client 102 is configured to forward its HTTP requests to proxy server 103 via the Internet 110. This is shown as the dotted line 201. As in system 100, the proxy server 103 communicates with Web server 101 to obtain the requested information on behalf of client 102. This is shown as the dotted line 202.

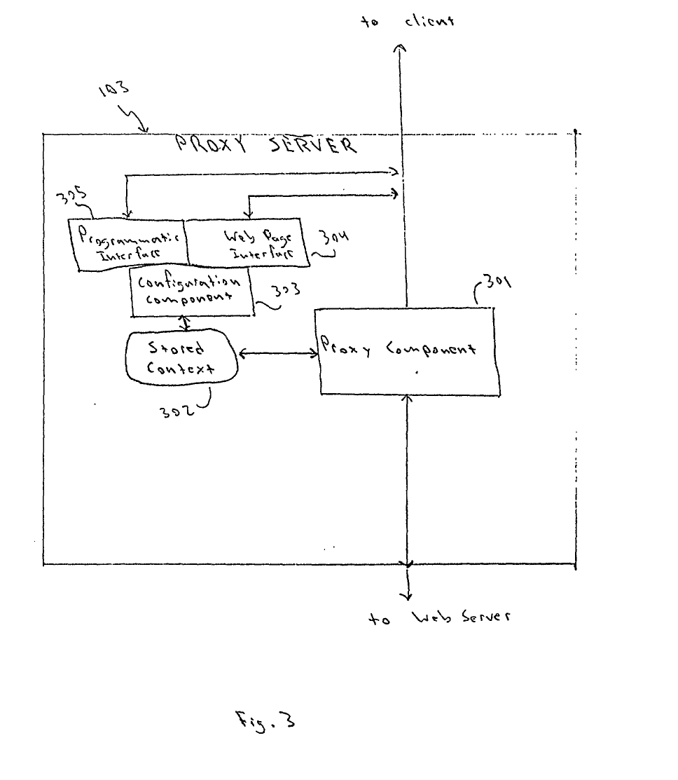

FIG. 3 shows a diagram depicting the software based components executing on the computer system platform provided by proxy server 103. As shown in FIG. 3, a proxy component 301 is used to service the HTTP requests from the client (e.g., client 102) and to the Web server (e.g., Web server 101). The proxy component 301 appends the user context to the HTTP requests from the client. The user context is stored within the proxy server 103, shown as stored context 302.

As depicted in FIG. 3, the proxy server functionality of the present embodiment comprises two main components: the proxy component 301 that retrieves the context information in the stored context 302 to append it to the client HTTP requests, and the configuration component 303 that configures and stores the context 302. The stored context 302 can be modified and queried using a Web page interface 304 or using a programmatic interface 305. For example, some pieces of stored context are not likely to change often and are typically manually set up by the user using the Web interface 304. For instance, the identity and the preferences of the user are not likely to change often. Other pieces of stored context, such as the user's location, need to be updated regularly using the programmatic interface 305.

In the present embodiment, the proxy component 301 functions as an HTTP proxy that appends user context information to the outgoing HTTP requests of the client. This contextual information can then be retrieved by the destination Web server and used to customize the response to the client. Contextual information can typically be the physical location of the client, his identity, his device capability (if he is browsing the Web with a PDA or a laptop), his preferences, and the like.

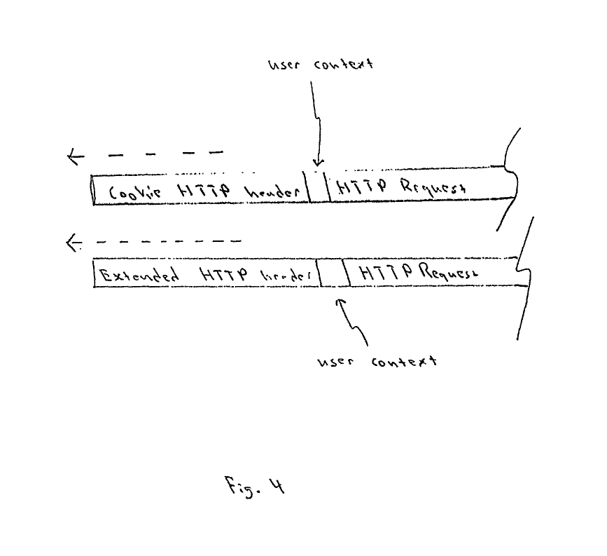

FIG. 4 shows a diagram depicting user context information appended to an HTTP request using a traditional cookie HTTP header and user context information appended to an HTTP request using an extended HTTP header.

An HTTP header comprises a set of data at the beginning of an HTTP response that is sent by the Web server back to the Web browser. It includes the date, size and type of file being sent. In one embodiment, this contextual information is appended to the HTTP requests of the client using either the traditional Cookie HTTP header (e.g., Cookie:Identity=user name; location=URL_of_the_location, etc.). This case is shown at the top of FIG. 4. Alternatively, an extended HTTP header (e.g.:x-cooltown-identity=user name, x-cooltown-location=URL_of_the_location, etc.) can be used, and is shown at the bottom FIG. 4.

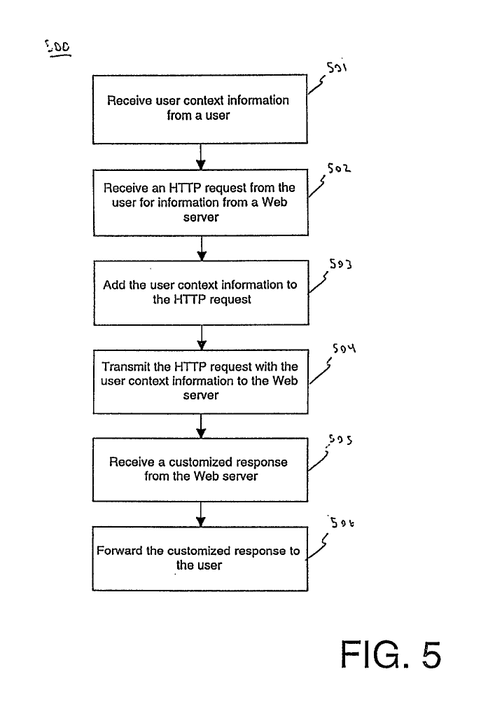

FIG. 5 shows a flow chart of the steps of a proxy server based method 500 for providing user context information to customize responses from a Web server in accordance with one embodiment of the present invention. Method 500 shows the steps performed by system in accordance with the present invention (e.g., system 100) in providing user context information.

Method 500 begins in step 501 where user context information is received from a user. As described above, this user context information is stored within the proxy server 103 as stored context 302. The user context information can be entered through either a programmatic interface 305 or a Web page interface 304. The user context information can include user location information or user identity information. In step 502, an HTTP request from the user (e.g., client 102) for information from a Web server 101 is received by the proxy server 103. In step 503, the user context information is added to the HTTP request. In step 504, the HTTP request is transmitted to the Web server 101 with the user context information appended thereto. As described above, the user context information can be appended to the HTTP request by using a cookie HTTP header or by using an extended HTTP header. In step 505, a customized response is received by the proxy server 103 from the Web server 101. In step 506, the customized response is then forwarded to the user 102.

Thus, embodiments of the present invention are directed towards a method and system for a context manager proxy that provides a solution that facilitates the customization of information presented from a variety of different Web sites or Web portals with respect to an individual user. The present invention automatically transmits context information in accordance with the widely used Internet communication standards to allow the customization of responses from various Web sites or Web portals.

Computer System Environment

Referring to FIG. 6, a computer system 612 is illustrated. Within the following discussions of the present invention, certain processes and steps are discussed that are realized, in one embodiment, as a series of instructions (e.g., software program) that reside within computer readable memory units of system 612 and executed by processors of system 612. When executed, the instructions cause computer system 612 to perform specific actions and exhibit specific behavior which was described in detail above.

Specific aspects of the present invention are operable within a programmed computer system which can function as a client, or a server, or a proxy machine. A generalized example of such a computer system operable to implement the elements of the present invention is shown in FIG. 6. In general, the computer system of the present invention includes an address/data bus 600 for communicating information, one or more central processor(s) 601 coupled with bus 600 for processing information and instructions, a computer readable volatile memory unit 602 (e.g., random access memory, static RAM, dynamic RAM, etc.) coupled with bus 600 for storing information and instructions for the central processor(s) 601, a computer readable non-volatile memory unit 603 (e.g., read only memory, programmable ROM, flash memory, EPROM, EEPROM, etc.) coupled with bus 600 for storing static information and instructions for processor(s) 601. System 612 can optionally include a mass storage computer readable data storage device 604, such as a magnetic or optical disk and disk drive coupled with bus 600 for storing information and instructions. Optionally, system 612 can also include a display device 605 coupled to bus 600 for displaying information to the computer user, an alphanumeric input device 606 including alphanumeric and function keys coupled to bus 600 for communicating information and command selections to central processor(s) 601, a cursor control device 607 coupled to bus for communicating user input information and command selections to the central processor(s) 601, and a signal input/output device 608 coupled to the bus 600 for communicating messages, command selections, data, etc., to and from processor(s) 601.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. A method for providing user context information to customize responses from a Web server, comprising:
receiving user context information from a user;
receiving an HTTP request from the user for information from a Web server;
adding the user context information to the HTTP request; and
transmitting the HTTP request with the user context information to the Web server to obtain a customized response from the Web server for the user.

2. The method of claim 1 further including storing the user context information received from the user.

3. The method of claim 1 further including receiving the user context information in accordance with Internet communication standards.

4. The method of claim 1 further including transmitting the customized response from the Web server to the user.

5. The method of claim 1 wherein the HTTP request with the user context information is transmitted using a proxy server.

6. The method of claim 5 wherein the customized response from the Web server is received using the proxy server and forwarded to the user.

7. The method of claim 1 further including appending the user context information to the HTTP request by using a cookie HTTP header.

8. The method of claim 1 further including providing a Web page interface configured to allow the user to edit the user context information.

9. The method of claim 1 wherein the user context information includes user location information.

10. The method of claim 1 wherein the user context information includes user identity information.

11. In a client/server computer system, a method for providing user context information to customize responses from a Web server, the method comprising:
receiving user context information from a user, the user context information received by a proxy server;
receiving an HTTP request at the proxy server from the user for information from a Web server;
adding the user context information to the HTTP request;
transmitting the HTTP request with the user context information from the proxy server to the Web server;
receiving a customized response from the Web server at the proxy server; and
forwarding the customized response from the Web server to the user.

12. The method of claim 11 further including storing the user context information received from the user in the proxy server.

13. The method of claim 11 further including receiving the user context information in accordance with Internet communication standards.

14. The method of claim 11 further including appending the user context information to the HTTP request by using a cookie HTTP header.

15. The method of claim 11 further including providing a Web page interface configured to allow the user to edit the user context information.

16. The method of claim 11 further including providing a programmatic interface configured to allow the user to edit the user context information.

17. The method of claim 11 wherein the user context information includes user location information.

18. The method of claim 11 wherein the user context information includes user identity information.

19. A proxy server computer system for implementing a method for providing user context information to customize responses from a Web server, comprising:
a microprocessor for executing computer readable code; and
a memory for storing computer readable code, which when executed by the microprocessor cause the proxy server computer system to perform:
receiving user context information from a user;
receiving an HTTP request from the user for information from a Web server;
adding the user context information to the HTTP request; and
transmitting the HTTP request with the user context information to the Web server to obtain a customized response from the Web server for the user.

20. The system of claim 19 further including storing the user context information received from the user.

21. The system of claim 19 further including receiving the user context information in accordance with Internet communication standards.

22. The system of claim 19 wherein the customized response from the Web server is received at the proxy server computer system and forwarded to the user.

23. The system of claim 19 further including appending the user context information to the HTTP request by using a cookie HTTP header.

24. The system of claim 19 further including providing a Web page interface configured to allow the user to edit the user context information.

25. The system of claim 19 wherein the user context information includes user location information.

26. The system of claim 19 wherein the user context information includes user identity information.
